(19) United States
(12) Patent Application Publication
(10) Pub. No.: US 2023/0033897 A1
(43) Pub. Date: Feb. 2, 2023

(54) A METHOD FOR ENHANCING COLOR RICHNESS OF DISPLAYS

(71) Applicant: BILKENT UNIVERSITESI (UNAM) ULUSAL NANOTEKNOLOJI ARASTIRMA MERKEZI, Ankara (TR)

(72) Inventors: Hilmi Volkan DEMIR, Ankara (TR); Evren MUTLUGUN, Ankara (TR)

(73) Assignee: BILKENT UNIVERSITESI (UNAM) ULUSAL NANOTEKNOLOJI ARASTIRMA MERKEZI, Ankara (TR)

(21) Appl. No.: 17/789,605

(22) PCT Filed: Dec. 28, 2020
(86) PCT No.: PCT/TR2020/051416

§ 371 Date: Jun. 28, 2022

(30) Foreign Application Priority Data
Dec. 31, 2019 (TR) 2019/22816

(51) Int. Cl. B29D 11/00; G02B 5/20; F21V 8/00

(52) U.S. Cl. CPC B29D 11/00875; G02B 5/206; G02B 6/0065; G02B 6/0043; G02B 2207/101

(57) ABSTRACT

The present invention relates to a method (100) for widening color space with a much reduced thickness compared to film applications, by coating lower and upper surfaces of a light waveguide that is used within displays such as tablet and mobile phone with color enriching materials.

### TECHNICAL FIELD

The present invention relates to a method for widening color space with a much reduced thickness compared to film applications, by coating lower and upper surfaces of a light waveguide—that is used within displays such as tablet and mobile phone—with color enriching materials.

### BACKGROUND OF THE INVENTION

Quantum dot films are used in display technologies in order to increase color richness. Being diffused between a moisture and oxygen barrier film in a polymer matrix; quantum dots enter between optical layers existing in displays, as a new layer. However, particularly in displays wherein physical fineness is important such as tablet and mobile phone, inserting a new physical layer into a display does not meet the thickness requests of such devices. Therefore, there is need for a method which enables to integrate nanostructures such as color-enriching quantum dots into a light waveguide being used within a display, in such a way that they will not increase the display thickness too much; and ensures new nanostructures to be integrated.

The Chinese patent document no. CN104536078, an application in the state of the art, discloses a quantum dot display device which achieves a wide color gamut at a low color. A dichroic filter-enhanced fluorescent light guide plate is located on the quantum dot display device. The light guide plate is coated with an optical coating composition. The optical coating composition containing the quantum dots is applied on the surface of the light guide plate by a spraying coating method and it has a thickness of 40 um. After coating, the light guide plate is cured upon being heated at 80° C. for 20 minutes. However, coating of structures such as nanoplate is not disclosed in the said patent except quantum dots.

The Chinese patent document no. CN103955093, an application in the state of the art, discloses an optical plate based on quantum dots. The optical plate is coated with quantum dots capable of converting blue light into red and green light. The coating process is carried out by fixing the quantum dots on the optical plate by spraying. The optical plate based on quantum dots can be used as a light guide plate. However, coating of structures such as nanoplate is not disclosed in the said patent except quantum dots.

The Chinese patent document no. CN108957847, an application in the state of the art, discloses a liquid crystal display whereon a quantum dot film with a high water-oxygen barrier is mounted. The quantum dot film with the high water-oxygen barrier comprises a quantum dot layer, a first substrate and a second substrate. The quantum dot layer is arranged between the first substrate and the second substrate. The liquid crystal display comprises a light guide plate and a quantum dot film with a high water-oxygen barrier. The quantum dot film with the high water-oxygen barrier is arranged on the light guide plate and the light guide plate is enabled to have a strong water and oxidation resistance. However, the said patent does not disclose how the barrier layer is placed on the surface.

### SUMMARY OF THE INVENTION

An objective of the present invention is to realize a method for widening color space with a much reduced thickness compared to film applications, by coating upper and lower surfaces of a light waveguide—that is used within displays such as tablet and mobile phone—with color enriching materials.

Another objective of the present invention is to realize a method for coating a light waveguide in displays with quantum dots and nanoplates in order to provide color enrichment.

### DETAILED DESCRIPTION OF THE INVENTION

“A Method for Enhancing Color Richness of Displays” realized to fulfil the objectives of the present invention is shown in the FIGURE attached, in which:

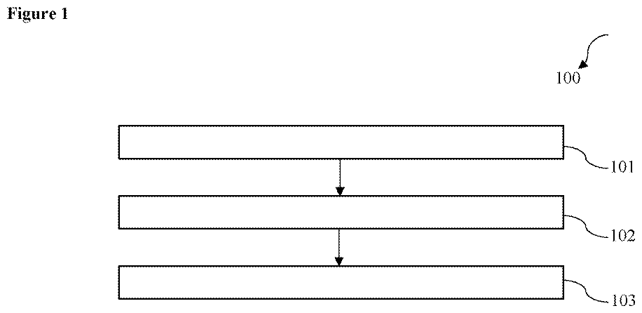

FIG. 1 is a view of a flowchart of the inventive method.

100. Method

The inventive method (100) for widening color space with a much reduced thickness compared to film applications in displays such as tablet and mobile phone comprises steps of:
coating materials, which form an oxygen and moisture barrier, on lower and upper surface of a light waveguide being used in displays by spray coating (101);
coating color enriching materials on the light waveguide, which is coated with an oxygen and moisture barrier on the upper and lower surface thereof, by spray coating (102); and
re-coating the light waveguide, which is coated with a color enriching material, with a material forming an oxygen and moisture barrier (103).

In the inventive method (100); before a light waveguide being used in edge-lit displays is integrated into the related display, its upper and lower surfaces are coated with spraying transparent metal oxide nanoparticle solutions, i.e. preferably Al₂O₃ nanoparticles which enable to form an oxygen and moisture barrier (101). Surfaces of a light waveguide—upper and lower surfaces of which are coated with transparent metal oxide nanoparticle solutions—are coated with quantum dot and nanoplate solutions having color enriching characteristic by means of spraying method (102). The quantum dots used enable to increase color richness in display technologies; whereas nanoplates provide sharp (pure) colors and have a high absorption coefficient. Lastly, upper and lower surfaces of the light waveguide coated with color enriching materials are coated by spraying transparent metal oxide nanoparticle solutions—preferably Al₂O₃ nanoparticle—in order to protect them against oxygen and moisture (103).

With the inventive method (100), a sandwich-like structure is created by coating upper and lower surfaces of a light waveguide with a material forming an oxygen and moisture barrier, a color enriching material and again a material forming an oxygen and moisture barrier, respectively. A structure obtained in this way enables to form a physically fine structure without requiring an extra film thickness particularly on small-area displays.

The inventive method (100) enables to obtain fine surfaces which avoid unwanted display thickness that may occur by inserting a new physical layer into the display, in displays wherein physical fineness is important.

In an embodiment of the invention, the said method (100) can be applied by using materials that will meet the color requests required for monochrome color converter application on light-diffusing layers as well.

Within these basic concepts; it is possible to develop various embodiments of the inventive method (100) for enhancing color richness of displays; the invention cannot be limited to examples disclosed herein and it is essentially according to claims.

1. A method (100) for widening color space with a much reduced thickness compared to film applications in displays such as tablet and mobile phone, characterized by steps of:
coating materials, which form an oxygen and moisture barrier, on lower and upper surface of a light waveguide being used in displays by spray coating (101);
coating color enriching materials on the light waveguide, which is coated with an oxygen and moisture barrier on the upper and lower surface thereof, by spray coating (102); and
re-coating the light waveguide, which is coated with a color enriching material, with a material forming an oxygen and moisture barrier (103).

2. A method (100) according to claim 1; characterized in that before a light waveguide being used in edge-lit displays is integrated into the related display, its upper and lower surfaces are coated by spraying transparent metal oxide nanoparticle solutions, i.e. preferably Al₂O₃ nanoparticles which enable to form an oxygen and moisture barrier (101).

3. A method (100) according to claim 2; characterized in that surfaces of a light waveguide—upper and lower surfaces of which are coated with transparent metal oxide nanoparticle solutions—are coated with quantum dot and nanoplate solutions having color enriching characteristic by means of spraying method (102).

4. A method (100) according to claim 3; characterized in that the quantum dots used increase color richness in display technologies; whereas nanoplates provide sharp (pure) colors and have a high absorption coefficient.

5. A method (100) according to claim 4; characterized in that upper and lower surfaces of the light waveguide coated with color enriching materials are coated by spraying transparent metal oxide nanoparticle solutions—preferably Al₂O₃ nanoparticle—in order to protect them against oxygen and moisture (103).
